(19) United States
(12) Patent Application Publication
(10) Pub. No.: US 2005/0234687 A1
(43) Pub. Date: Oct. 20, 2005

(54) Grid dividing method, grid dividing apparatus, computer readable recording medium recorded thereon grid dividing program, and computer readable recording medium recorded thereon data converting program

(75) Inventors: Makoto Sakairi, Kawasaki (JP); Mami Nakadate, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/135,432

(22) Filed: May 24, 2005

Related U.S. Application Data
(63) Continuation of application No. PCT/JP03/06747, filed on May 29, 2003.

(51) Int. Cl. G06F 17/10

(52) U.S. Cl. 703/2; 703/1; 345/424

(57) ABSTRACT

In a technique for dividing an object, which is to be analyzed numerically and is made up of a plurality of components, into grids to generate fundamental elements, grid setting according to the situation becomes possible, and the time required for grid division or analysis can be shortened while securing sufficient precision of analysis. This invention involves a setting step of, in a data converting process, setting an allowable range of an aspect ratio of fundamental elements for numerical analysis to each of the components, a cube dividing step of, in the data converting process, dividing each of the components into a plurality of cubes within the aspect ratio allowable range to generate a cube division model, and a grid dividing step of dividing each of the components into grids according to the cube division model to generate fundamental elements for numerical analysis.

### TECHNICAL FIELD

The present invention relates to a technique for dividing an object, which is to be analyzed numerically and is made up of a plurality of components, into grids to generate fundamental elements for numerical analysis. Particularly, the present invention relates to a technique for, when geometric shape data [for example, polygon data, CAD (Computer Aided Design) data] of the object to be analyzed numerically is converted into data for numerical analysis, dividing each of the components into cubes to divide the object to be analyzed numerically into grids.

### BACKGROUND ART

When numerical analysis such as structure analysis, mechanism analysis, heat transfer analysis, fluid analysis, thermal fluid analysis, electromagnetic field analysis, magnetic field analysis or the like is performed with the use of a computer, it is general that an object to be analyzed numerically is divided into grids (mesh division) to generate cubic (solid, rectangular parallelepiped) fundamental elements for numerical analysis (mesh elements, grid elements), a characteristic value representing the characteristic of each of the fundamental elements is determined, and the object to be numerically analyzed is approximated by a set of the fundamental elements, whereby the numerical analysis is efficiently performed.

With recent reductions in size and weight of electronic apparatuses which are computer peripheral devices, it is demanded to analyze highly accurately the behaviors of heat in a complex structure of an electronic device because there is a demand for a design of a structure that can appropriately control behaviors of heat generated by such electronic apparatus, particularly, a printer and the like. To meet this demand, thermal fluid analysis software [for example, FLOTHERM (registered trademark of Flomerics)] has been developed as a tool for carrying out analysis in a computer. When numerical analysis is carried out with the use of this software, data (mesh data) of fundamental elements obtained by dividing the object as above is used.

Recently, there has been developed automatic converting software (for example, Simulation-HUB and the like) for converting CAD data (geometric shape data, three-dimensional solid model data) obtained by a CAD system (for example, Pro/E, I-DEAS, Parasolid, AutoCAD, VPS or the like) into data for numerical analysis used for numerical analysis with the use of various kinds of software.

This automatic converting software converts geometric shape data as it is into corresponding data for numerical analysis, and outputs it, normally. As shown in FIG. 12, for example, geometric shape data of a model made up of two components, which are a substrate 100 and an LSI chip 200 mounted on the substrate 100, is converted into data for numerical analysis of the components by automatic converting software 300.

Before the numerical analysis by any one of various kinds of software for numerical analysis (for example, FLORTHERM) is started, each component given by the data for numerical analysis obtained with the use of the automatic converting software 300 is divided into a plurality of fundamental elements. When grids are generated with the use of such grid generating software, the operator or the like can select and designate the number of the fundamental elements (the number of grids) obtained by grid division in two modes, “large” and “small.”

When the operator selects that the number of grids is small, grid division/fundamental element generation is performed as shown in FIG. 13(A), for example. In the example shown in FIG. 13(A), a model made up of two components, which are a substrate 100 and an LSI chip 200, is divided according to a setting that the number of grids is small, like the example shown in FIG. 12. In concrete, grids (meshes) having lattice points at vertexes of the two components 100 and 200 are automatically generated, whereby the fundamental elements are generated, as denoted by broken lines in FIG. 13(A). When the number of grids is small as this, the precision of the analysis with the use of software for numerical analysis degrades, but the time required for grid division or numerical analysis is largely shortened.

When the operator selects that the number of grids is large, grid division/fundamental element generation is performed as shown in FIG. 13(B). In the example shown in FIG. 13(B), a model made up of two components, which are a substrate 100 and an LSI chip 200, is divided according to a setting that the number of grids is large, like the example shown in FIG. 12. In concrete, fundamental elements (meshes) having an appropriate number of lattice points are automatically generated between vertexes of the two components 100 and 200 so that an appropriate number of fundamental elements (grids) are generated, as denoted by broken lines in FIG. 13(B). When the number of grids is large as this, the precision of analysis with the use of software for numerical analysis is improved, but a long time is required for grid division or numerical analysis.

In the above grid generating software, the number of grids can be set to only “large” or “small,” and an aspect ratio (ratio of height to width to length) of fundamental elements for numerical analysis cannot be set for each component of an object to be analyzed numerically. Thus, it is impossible to set grid division according to the situation.

When there is a component whose result of numerical analysis should be watched, for example, it is so set that the fundamental elements are finely generated in the component and a portion in the vicinity of the component, whereas the fundamental elements are coarsely generated in portions other than the above. If doing so, it is considered that the time required for grid division or numerical analysis can be shortened while sufficient precision of analysis can be secured for the component to be watched. However, a setting according to the situation is impossible in the present grid generating software.

In the light of the above problem, an object of the present invention is to provide a technique that can set an allowable range of an aspect ratio of fundamental elements of each component when geometric shape data is converted into data for numerical analysis, can set grid division according to the situation, and can shorten the time required for grid division or analysis while securing sufficient precision of analysis.

### DISCLOSURE OF INVENTION

To achieve the above object, the present invention provides a grid dividing method comprising a setting step of, in a data converting process for converting geometric shape data of an object, which is to be analyzed numerically and is made up of a plurality of components, into data for numerical analysis, setting, for each of the components, an allowable range of aspect ratios of fundamental elements which are used for numerical analysis and are to be obtained by dividing the component into grids, a cube dividing step of, in the data converting process, dividing each of the components into a plurality of cubes within the allowable range set at the setting step to generate a cube division model (model for numerical analysis), and a grid dividing step of dividing each of the components into grids according to the cube division model obtained at the cube dividing step to generate the fundamental elements.

The present invention further provides a grid dividing apparatus comprising a setting means for, in a data converting process for converting geometric shape data of an object, which is to be analyzed numerically and is made up of a plurality of components, into data for numerical analysis, setting, for each of the components, an allowable range of aspect ratios of fundamental elements which are used for numerical analysis and are to be obtained by dividing the component into grids, a cube dividing means for, in the data converting process, dividing each of the components into a plurality of cubes within the allowable range set by the setting means to generate a cube division model, and a grid dividing means for dividing each of the components into grids according to the cube division model obtained by the cube dividing means to generate the fundamental elements.

The present invention still further provides a grid dividing program for making a computer execute a function of dividing an object, which is to be analyzed numerically and is made up of a plurality of components, into grids to generate fundamental elements for numerical analysis, the grid dividing program making the computer function as a setting means for, in a data converting process for converting geometric shape data of the object into data for numerical analysis, setting, for each of the components, an allowable range of aspect ratios of the fundamental elements, a cube dividing means for, in the data converting process, dividing each of the components into a plurality of cubes within the allowable range set by the setting means to generate a cube division model (model for numerical analysis), and a grid dividing means for dividing each of the components into grids according to the cube division model obtained by the cube dividing means to generate the fundamental elements.

The present invention still further provides a data converting program for making a computer execute a function of a data converting process for converting geometric shape data of an object, which is to be analyzed numerically and is made up of a plurality of components, into data for numerical analysis, the data converting program making the computer function as a setting means for setting, for each of the components, an allowable range of aspect ratios of fundamental elements which are used for numerical analysis and are to be obtained by dividing the component into grids, and a cube dividing means for dividing each of the components into a plurality of cubes within the allowable range set by the setting means to generate a cube division model (model for numerical analysis).

A computer readable recording medium according to the present invention is recorded thereon the above grid dividing program or the above data converting program.

According to the present invention, when geometric shape data is converted into data for numerical analysis, a cube division model in which each of components of an object to be analyzed numerically is divided into a plurality of cubes (parts) within a desired aspect ratio allowable range, is generated, and grid division (division into fundamental elements for numerical analysis at desired aspect ratios) is performed according to the cube division model. It is thus possible to set grid division according to the situation, decrease the number of grids while securing sufficient precision of analysis, and largely decrease the time required for grid division or analysis, only by changing a little data converting software for converting geometric data into data for numerical analysis, without changing existing grid generating software or software for numerical analysis. Particularly, when there is a component whose result of numerical analysis should be watched, it is possible to set the aspect ratios so that fundamental elements are finely generated in the component and a portion in the vicinity of the component, whereas the fundamental elements are coarsely generated in portions other than the above. Accordingly, it is possible to shorten the time required for grid division or numerical analysis while securing sufficient precision of analysis for the component to be watched.

The user can recognize and select a cube division model requiring the shortest possible time, or a model having the highest possible analysis precision among a plurality of cube division models generated for respective plural aspect ratio allowable ranges while referring to information on analysis times and precision ratios and considering the information.

In cube division, a component whose result of analysis should be watched is first divided into cubes, whereby fundamental elements are finely generated in the watched component, whereas the fundamental elements are coarsely generated in components other than the above. On this occasion, each component is divided into cubes of the maximum size within an aspect ratio allowable range. Thus, it is possible to perform the cube division without increasing the number of fundamental elements (the number of grids).

In grid division, a result of cube division of a cube division model can be used as it is as a result of grid division. It is thereby possible to perform grid division (fundamental element generation) at very high speed with the use of existing grid generating software without changing the grid generating software.

### BRIEF DESCRIPTION OF DRAWINGS

FIG. 1 is a block diagram showing a functional structure of a grid dividing apparatus according to an embodiment of this invention;

FIG. 2 is a flowchart for illustrating a flow of the whole process of the embodiment;

FIG. 3 is a diagram for illustrating a converting process (cube dividing process) by a converting means according to the embodiment;

FIG. 4 is a diagram for illustrating a grid generating operation by a gird generating program (grid dividing means) according to the embodiment;

FIG. 5 is a flowchart for illustrating an operation of the grid dividing apparatus shown in FIG. 1;

FIG. 6 is a perspective view showing a practical example of an object to be analyzed numerically;

FIG. 7 is a diagram showing an example of a screen for inputting a setting of an allowable range of aspect ratios for the object to be analyzed numerically shown in FIG. 6, displayed on a display unit of the grid dividing apparatus shown in FIG. 1;

FIG. 8 is a diagram showing a screen for selecting a cube division model of the object to be analyzed numerically shown in FIG. 6, displayed on the display unit of the grid dividing apparatus shown in FIG. 1;

FIG. 9 is a diagram showing a practical example of the object to be analyzed numerically in order to explain cube division (grid division) according to the embodiment;

FIG. 10 is a diagram showing an example where normal grid division is performed on the object to be analyzed numerically shown in FIG. 9;

FIGS. 11(A) through 11(D) are diagrams for illustrating a procedure of a cube dividing (grid dividing) process performed on the object to be analyzed numerically shown in FIG. 9 with the use of the grid dividing apparatus according to the embodiment;

FIG. 12 is a diagram for illustrating a process of converting geometric shape data into data for numerical analysis by known automatic converting software; and

FIGS. 13(A) and 13(B) are diagrams for illustrating a grid generating operation of known grid generating software.

### BEST MODE FOR CARRYING OUT THE INVENTION

Hereinafter, description will be made of an embodiment of the present invention with reference to the drawings.

### (1) DESCRIPTION OF AN EMBODIMENT OF THE INVENTION

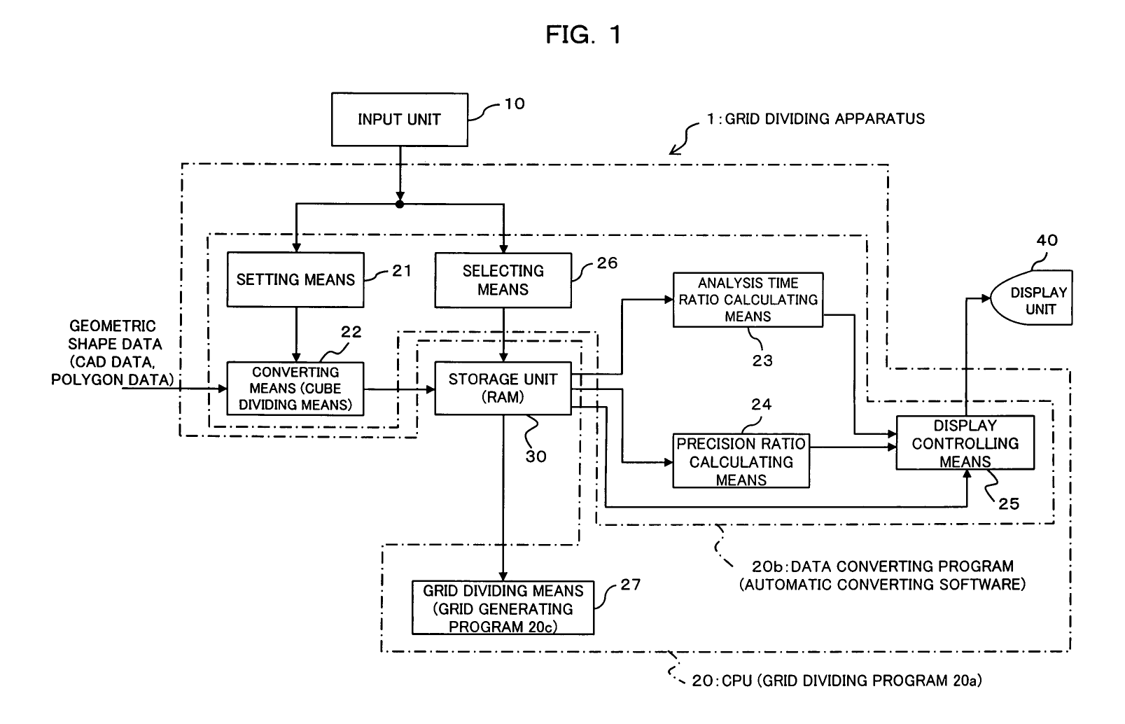

FIG. 1 is a block diagram showing a functional structure of a grid dividing apparatus according to an embodiment of this invention. A grid dividing apparatus 1 according to this embodiment shown in FIG. 1 is realized by executing a grid dividing program 20a including a data converting program 20b and a grid generating program 20c in an information processing apparatus such as a personal computer or the like. The grid dividing apparatus 1 comprises at least an input unit 10, a CPU 20, a storage unit 30 and a display unit 40.

The input unit 10 is operated by an operator or the like to instruct the CPU 20 to input aspect ratios or select a cube division model, as will be described later. The input unit 10 is comprised of a mouse, a keyboard or the like.

The CPU 20 executes the grid dividing program 20a including the data converting program 20b and the grid generating program 20c to be described later to fulfill functions of various means 21 through 27 to be described later.

The storage unit 30 is used as a working memory or the like when the CPU 20 executes the program 20a in order to fulfill the functions of the various means 21 through 27. The storage unit 30 is comprised of a RAM (Random Access Memory), for example.

The display state of the display unit 40 is controlled by a display controlling means 25 to be described later. The display unit 40 displays a screen for inputting a setting of an allowable range of aspect ratios (refer to FIG. 7, for example) and a screen for selecting a cube division model (refer to FIG. 8, for example). The display unit 40 is comprised of a CRT (Cathode Ray Tube), an LCD (Liquid Crystal Display) or the like.

The CPU 20 executes the data converting program (automatic converting software such as Simulation-HUB or the like) 20b to function as a setting means 21, a converting means 22, an analysis time ratio calculating means 23, a precision ratio calculating means 24, a display controlling means 25 and a selecting means 26, while executing the exiting grid generating program (grid generating software) 20c to function as a grid dividing means 27.

The setting means 21 receives an instruction from the operator or the like through the input unit 10 to set an allowable range of an aspect ratio of fundamental elements for numerical analysis (mesh elements, grid elements) to be obtained by dividing each component at the time of a data converting process for converting geometric shape data (CAD data, polygon data or the like) of an object, which is to be numerically analyzed and is composed of a plurality of components, into data for numerical analysis. The setting means 21 receives an instruction from the operator or the like through the input unit 10 to be able to set a plurality of aspect ratio allowable ranges for one object to be numerically analyzed. Here, the fundamental element is a cube (cube, rectangular parallelepiped) and the aspect ratio is a ratio of height to width to length of the fundamental element. Hereinafter, the aspect ratio is handled as the ratio of height to width in this embodiment, for the sake of simplicity.

The converting means 22 converts geometric shape data inputted from the outside into data for numerical analysis. In this embodiment, the converting means 22 fulfills a function as being a cube dividing means which generates a cube division model by dividing each component of an object to be numerically analyzed into a plurality of cubes within an aspect ratio allowable range set by the setting means 21 at the time of the data converting process.

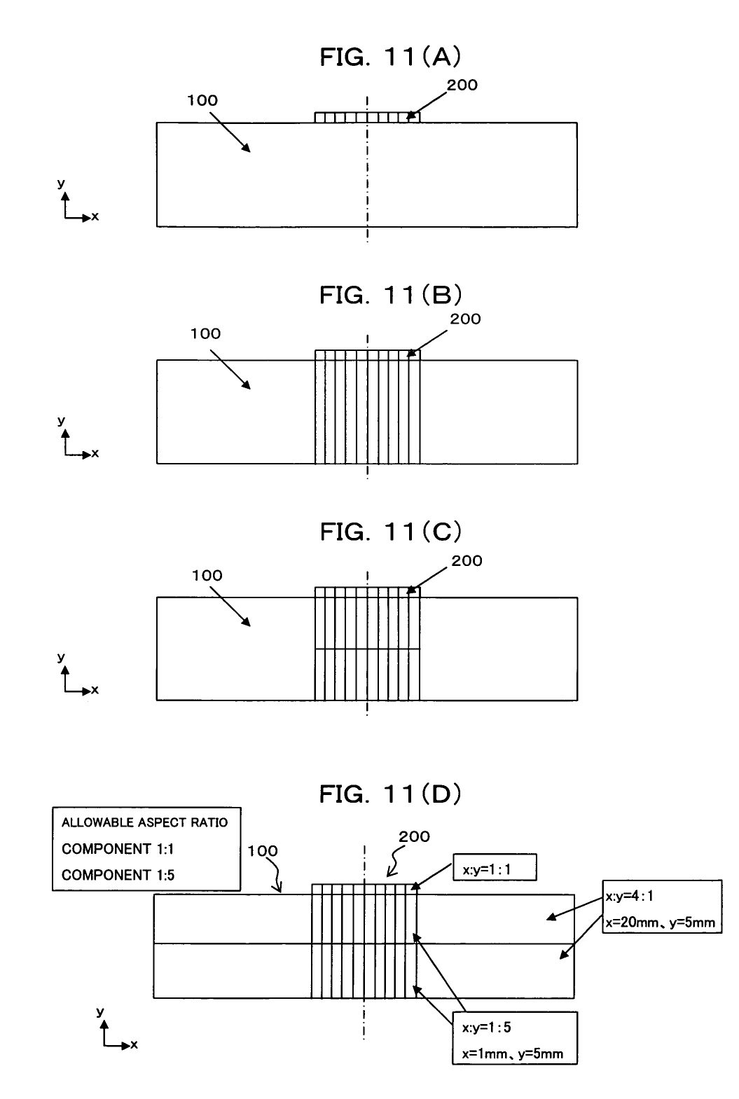

The converting means (cube dividing means) 22 generates a cube division model for each aspect ratio allowable range when the setting means 21 sets a plurality of the aspect ratio allowable ranges. The converting means (cube dividing means) 22 divides first a component whose result of numerical analysis is to be watched, and divides each of the components into cubes of the maximum size within an aspect ratio allowable region set to the component, as will be described later with reference to FIGS. 11(A) through 11(D). At least one cube division model generated by means of the function of the converting means as being the cube dividing means as above is written in the storage unit 30 from the converting means 22, and temporarily stored therein.

Meanwhile, the geometric shape data converted into data for numerical analysis by the converting means 22 is CAD data (three-dimensional solid model data) obtained by a CAD system such as Pro/E, I-DEAS, Parasolid, AutoCAD, VPS or the like. The geometric shape data may be inputted to the grid dividing apparatus 1 (CPU 20, converting means 22) using a recording medium (not shown) such as a flexible disk, a CD-ROM, a CD-R, a CD-RW, a DVD, a magnetic disk, an optical disk, a magneto-optic disk, an IC card, a ROM cartridge or the like, or may be transmitted from a CAD system or the like to the grid dividing apparatus 1 (CPU 20, converting means 22) over a communication line (not shown) and inputted to the grid dividing apparatus 1.

When the converting means 22 generates two or more cube division models, the analysis time ratio calculating means 23 calculates a ratio of the analysis time required for the numerical analysis performed with the use of each cube division model, on the basis of one cube division model and the number of cubes of each cube division model.

When the converting means 22 generates two or more cube division models, the accuracy ratio calculating means 24 calculates a ratio of precision of a result of the numerical analysis performed with the use of each cube division model, on the basis of one cube division model and the number of cube division models.

The display controlling means 25 controls the display state of the displaying unit 40 as described above. The display controlling means 25 displays a screen for inputting a setting of an allowable range of aspect ratios (refer to FIG. 7, for example) or a screen for selecting a cube division model (refer to FIG. 8, for example) on the display unit 40. Particularly, when the converting means 22 generates two or more cube division models, the display controlling means 25 according to this embodiment displays information on the cube division models as the cube division model selection screen on the display unit 40. On the selection screen, the analysis time ratio calculated by the analysis time ratio calculating means 23 and the precision ratio calculated by the precision ratio calculating means 24 are related to each cube division model and the number of fundamental elements (the number of grids) of the model and displayed, as will be described later with reference to FIG. 8, for example.

Even when the converting means 22 generates only one cube division model, the display controlling unit 25 displays the cube division model and the number of fundamental elements (the number of grids) of the model as a confirmation screen on the display unit 40, and prompts the operator or the like to confirm the generated cube division model.

The selecting means 26 is operated by the operator or the like who has referred to the above selection screen displayed on the display unit 40 through the input unit 10 to select one of the plural cube division models temporarily held in the storage unit 30. The selecting unit 26 receives a select instruction from the operator or the like through the input unit 10, and outputs a selected cube division model from the storage unit 30 to the grid dividing means 27. When the converting means 22 generates only one cube division model, the selecting means 26 is operated by the operator or the like who has referred to the above confirmation screen displayed on the display unit 40 through the input unit 20, and functions to output the cube division model temporarily held in the storage unit 30 to the grid dividing means 27 in response to an instruction from the operator or the like who approves the model.

The grid dividing means 27 is realized by executing the existing grid generating program 20c by the CPU 20 as described above. The grid dividing means 27 performs grid division (mesh division) on each component according to a cube division model sent from the storage unit 30, thereby generating cubic fundamental elements for numerical analysis. On this occasion, the grid dividing means 27 uses a result of cube division of the cube division model as it is as a result of grid division to generate fundamental elements (mesh elements, grid elements) (refer to FIG. 4, for example).

A part of or all the grid dividing program 20a, the data converting program 20b and the grid generating program 20c are provided as application programs in the form that the programs are recorded on a computer readable recording medium such as a flexible disk, a CD-ROM, a CD-R, a CD-RW, a DVD or the like. In such case, the computer (CPU 20) reads the programs 20a, 20b and 20c from the recording medium, transfers the programs to the internal storage apparatus or an external storage apparatus, stores the programs, and uses the same. Alternatively, the programs 20a, 20b and 20c may be recorded on a storage apparatus (recording medium) such as a magnetic disk, an optical disk, a magneto-optic disk or the like, and provided to the computer (CPU 20) from the storage apparatus over a communication line.

Here, the computer is a concept involving hardware and an operating system, which signifies hardware operating under control of the operation system. When the operation system is unnecessary and the application programs solely operate the hardware, the hardware itself corresponds to the computer. The hardware comprises at least a microprocessor such as a CPU or the like, and a means for reading the computer programs recorded on the recording medium. The above application programs involve program codes for making the computer realize the functions of the grid dividing apparatus 1. A part of the functions may be realized by not the application programs but the operating system.

As the recording medium according to this embodiment, usable are various kinds of media that the computer can read such as an IC card, a ROM cartridge, a magnetic tape, a punched card, an internal storage apparatus (memory such as a RAM, a ROM or the like) of the computer, an external storage or the like, a printed matter on which codes such as bar codes or the like are printed, etc., other than the above flexible disk, CD-ROM, CD-R, CD-RW, DVD, magnetic disk, optical disk, magneto-optic disk, etc.

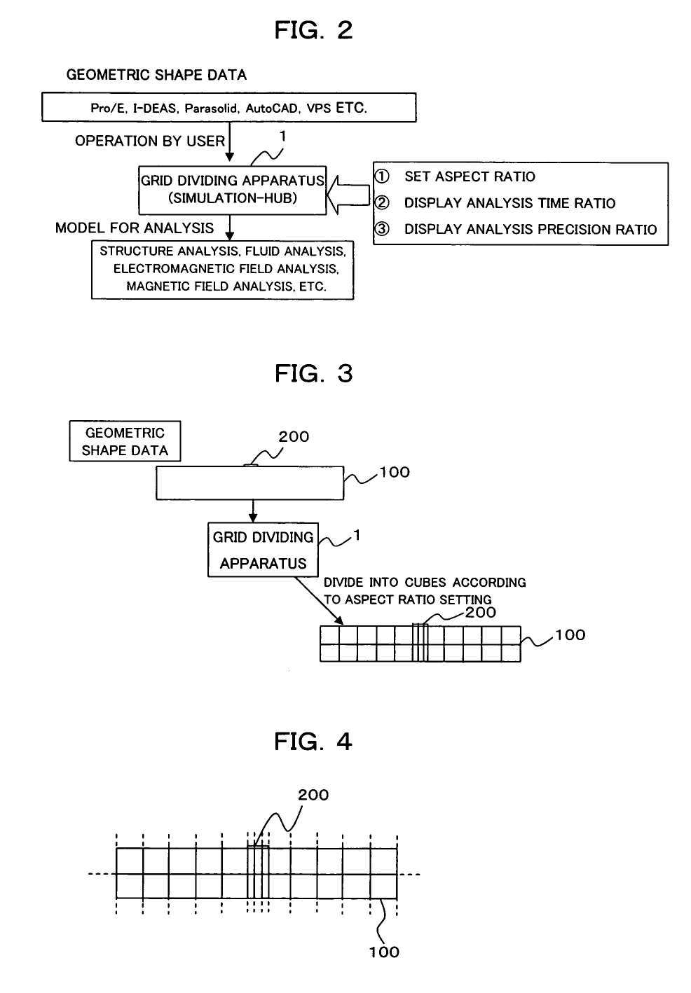

Next, description will be made of the operation of the grid dividing apparatus 1 having the above structure according to this embodiment, with reference to FIGS. 2 through 11.

FIG. 2 is a flowchart for illustrating a flow of the whole process according to this embodiment. FIG. 3 is a diagram for illustrating a converting process (cube dividing process) by the converting means 22 of this embodiment. FIG. 4 is a diagram for illustrating a grid generating operation by the grid generating program 20c (grid dividing means 27) of this embodiment.

In the grid dividing apparatus 1 according to this embodiment, when geometric shape data (CAD data, polygon data, three-dimensional solid model data) obtained by a CAD system such as Pro/E, I-DEAS, Parasolid, AutoCAD, VPS or the like is converted into data for numerical analysis, which is used for numerical analysis by various software, by the automatic converting software 20b such as Simulation-HUB or the like as shown in FIGS. 2 and 3, each component of an object to be numerically analyzed is divided into cubic parts within a desired aspect ratio allowable range set through the input unit 10 and the setting means 21, as shown in FIG. 3, and a cube division model is generated as a model for analysis.

On this occasion, the aspect ratio allowable range is inputted and set by user's operation (refer to \mathring{1} in FIG. 2). Practically, the maximum aspect ratio that can be allowed is inputted and set for each component, and the component is divided into cubes within the maximum aspect ratio.

When plural allowable ranges of aspect ratios are set for one object to be numerically analyzed, cube division models are generated for respective aspect ratio allowable ranges, and the generated plural cube division models are displayed along with analysis time ratios and analysis precision ratios described above as a selection screen (Viewer screen) as shown in FIG. 8 on the display unit 4 (refer to \mathring{2} and \mathring{3} in FIG. 2). The operator or the like who refers to this selection screen selects one cube division model through the input unit 10 and the selecting means 26.

A cube division model divided and selected as above is used as a model for analysis for the purpose of structure analysis, fluid analysis, electromagnetic field analysis, magnetic field analysis, etc, as shown in FIG. 2.

The grid dividing process is performed on the cube division model by the existing grid generating program 20c (grid dividing means 27), whereby fundamental elements for numerical analysis (grid elements, mesh elements) within a desired aspect ratio allowable range are generated. On this occasion, the grid dividing means 27 can generate fundamental elements at a desired aspect ratio only by generating grids (meshes) along the outer shape of a cubic component of the cube division model, as denoted by broken lines in FIG. 4.

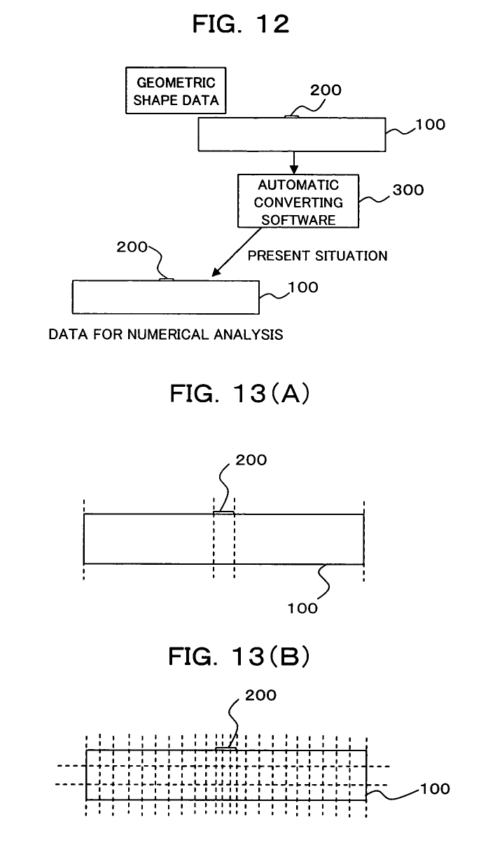

The cube division model shown in FIGS. 3 and 4 is obtained by dividing a model made up of two components, which are a substrate 100 and an LSI chip 200 mounted on the substrate 100, like the example shown in FIGS. 12, 13(A) and 13(B).

The grid division to be performed on a cube division model (model for analysis) may be performed by the grid generating program 20c (grid dividing means 27) in the grid dividing apparatus 1 as shown in FIG. 1, or may be performed by any one of various kinds of numerical analysis software.

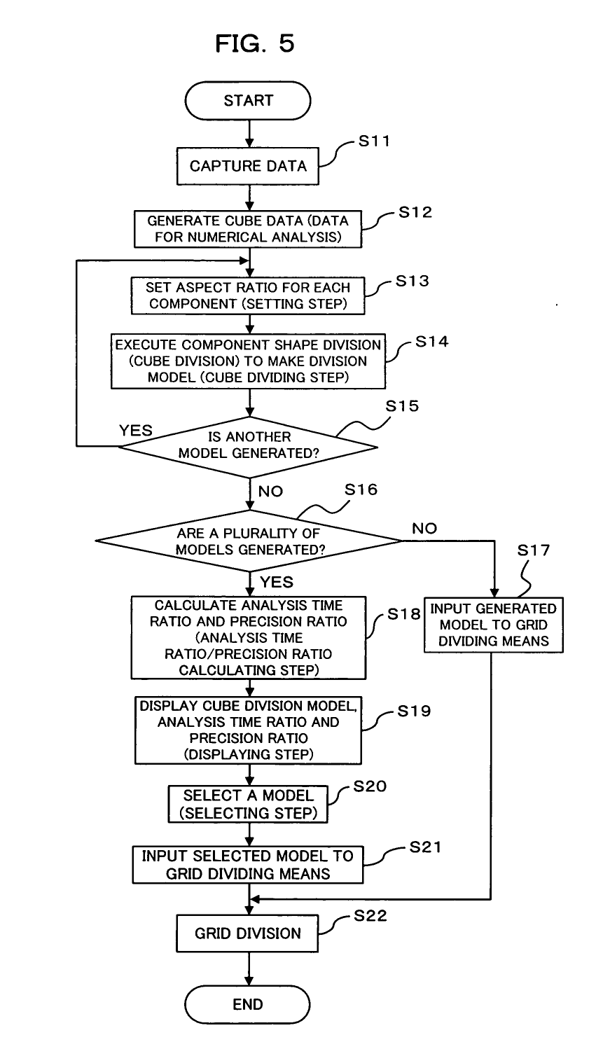

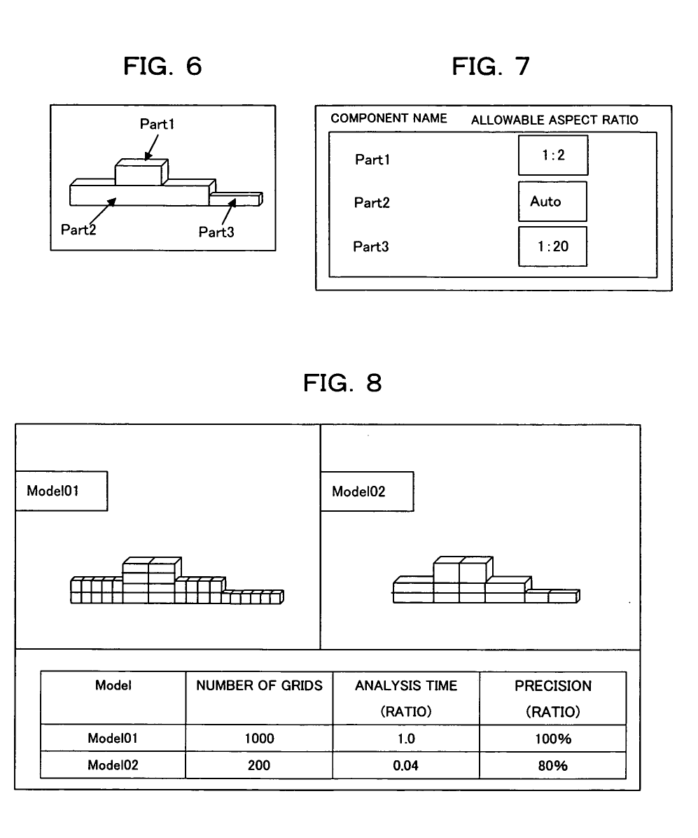

Next, description will be made of the operation of the grid dividing apparatus 1 shown in FIG. 1 with reference to a flowchart (steps S11 through S22) in FIG. 5, and diagrams in FIGS. 6 through 8. FIG. 6 is a perspective view showing a practical example of an object to be numerically analyzed. FIG. 7 is a diagram showing an example of the screen for inputting an aspect ratio allowable range for the object to be numerically analyzed in FIG. 6, displayed on the display unit 40 of the grid dividing apparatus 1 shown in FIG. 1. FIG. 8 is a diagram showing an example of the screen for selecting a cube division model of the object to be numerically analyzed in FIG. 6, displayed on the display unit 40 of the grid dividing apparatus 1 shown in FIG. 1.

When the grid dividing apparatus 1 captures geographic shape data of an object to be numerically analyzed made up of a plurality of components from any one of various recording media or over a communication line (step S11), the converting means 22 generates cube data (data for numerical analysis) of each of the components, using the function as being known automatic converting software (step S12). The cube data generated at step S12 is identical to data generated by the automatic converting software 300 shown in FIG. 12.

At this time, an allowable range of an aspect ratio of fundamental elements for numerical analysis to be obtained by dividing each component is set for the component (setting step; step S13). The setting of the aspect ratio is performed by the setting means 21 according to the data inputted by that the operator or the like operates the inputting unit 10.

In more concrete, when the aspect ratios are set for an object to be numerically analyzed made up of three components (Part 1, Part 2 and Part 3) as shown in FIG. 6, for example, a setting input screen as shown in FIG. 7, for example, is displayed on the display unit 40. On the setting screen, input columns for setting allowable aspect ratios (allowable maximum aspect ratios) for respective components are displayed. The operator or the like writes a desired aspect ratio in a setting input column for each component with use of the inputting unit 10 such as a mouse, keyboard or the like, whereby the setting means 21 sets the aspect ratio. In the example shown in FIG. 7, 1:2 is set as the allowable aspect ratio for the components Part 1, 1:20 as the allowable aspect ratio for the component Part 3, and “Auto” as the allowable aspect ratio for the component Part 2. The component Part 2 set “Auto” thereto is divided into as large cubes as possible according to a result of the cube division result of the neighboring components Part 1 and Part 3, without particularly limited with respect to its aspect ratio.

When performing the data converting process, the converting means 22 divides each component into a plurality of cubes within the aspect ratio allowable range according to the contents set at the setting step S13 to generate a cube division model (cube dividing step; step S14). At the cube dividing step S14, the cube division is performed first a component whose result of numerical analysis is to be watched, and each of the components is divided into cubic parts of the maximum size within the set aspect ratio allowable range.

A cube division model is generated according to the allowable range of one set of aspect ratios. After that, the operator is inquired as to whether another cube division model is generated according to the allowable ranges of another combination of aspect ratios through the display unit 40. When two or more cube division models are generated (YES route at step S15), the procedure returns to step S13, where the processes at step S13 and S14 as the above are repetitively executed.

When only one cube division model is generated by the converting means 22 (from NO route at step S15 to NO route at step S16), the cube division model and the number of fundamental elements of the model (the number of grids) are displayed as the confirmation screen on the display unit 40 to prompt the operator to confirm the generated cube division model. When the operator approves the model, the cube division model temporarily held in the storage unit 30 is inputted to the grid dividing means 27 (step S17).

On the other hand, when two or more grid division models are generated (from NO route at step S15 to YES route at step S16), the analysis time ratio calculating means 23 calculates a ratio of the analysis time required for the numerical analysis to be performed with the use of each of the cube division models obtained at the cube dividing step S14 on the basis of one cube division model and the number of cubes of the cube division model, and the precision ratio calculating means 24 calculates a ratio of precision of a result of the numerical analysis to be performed with the use of each of the cube division models on the basis of one cube division model and the number of cubes of the cube division model (analysis time ratio calculating step and precision ratio calculating step; step S18).

After that, information on two or more cube division models is displayed as a cube division model selection screen on the display unit 40 (displaying step; step S19). On this selection screen, the analysis time ratio and the precision ratio calculated at the calculating step S18 are related to each cube division model and the number of fundamental elements (the number of grids) of the model, and displayed. In the example shown in FIG. 8, shapes of two cube division models (Model01, Model02) having different allowable aspect ratios, the number of grids of each model, the analysis time and the precision ratio are displayed. Incidentally, the analysis time and the precision ratio on the selection screen shown in FIG. 8 are calculated on the basis (1) of Model01.

The operator or the like who refers to the above selection screen operates the input unit 10 while considering the analysis time and the precision ratio to designate and select one of the two or more cube division models (selecting step; step S20). The selected cube division model is inputted from the storage unit 30 to the grid dividing means 27 by the selecting means 26 (step S21).

When the cube division model is inputted to the grid dividing means 27 at steps S17 and S21, the grid dividing means 27 divides each of the components into grids (into meshes) according to the cube division model obtained at the cube dividing step S14, and fundamental elements for numerical analysis (mesh elements, grid elements) are generated using a result of cube division of the cube division model as it is as a grid division result (grid dividing step; step S22).

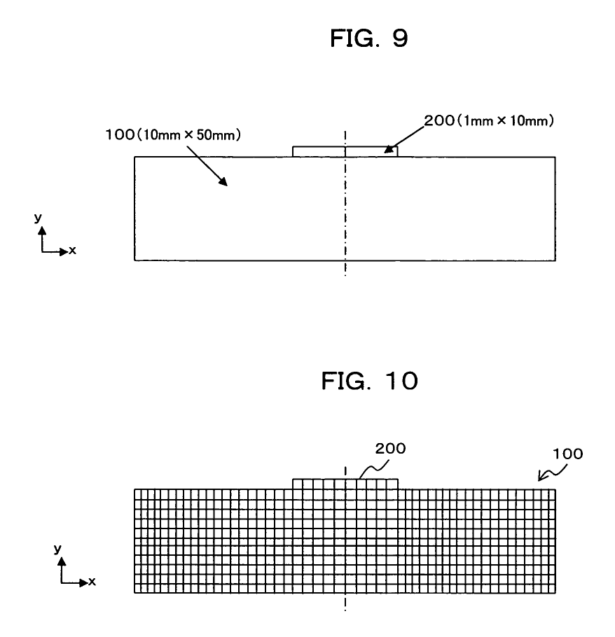

Now, description will be made of a practical example where the grid division according to this embodiment is performed on an object to be numerically analyzed (model made up of two components, which are a substrate 100 and an LSI chip 200 mounted on the substrate 100) similar to that shown in FIGS. 4, 12, 13(A) and 13(B), with reference to FIGS. 9, 10 and 11(A) through 11(D). FIG. 9 is a diagram showing a practical example of the object to be numerically analyzed. FIG. 10 is a diagram showing an example where the normal grid division is performed on the object to be numerically analyzed in FIG. 9 according to the setting that the number of grids is large. FIGS. 11(A) through 11(D) are diagrams for illustrating a processing procedure of cube division (grid division) performed on the object to be numerically analyzed in FIG. 9 with the use of the grid dividing apparatus 1 according to this embodiment.

As shown in FIG. 9, sizes in the x and y directions of the component (substrate) 100 are 50 mm and 10 mm, respectively, and sizes in the x and y directions of the component (LSI chip) 200 are 10 mm and 1 mm, respectively. A case where a rise in temperature of the component 200 is to be watched in thermal fluid analysis, that is, where the component 200 is a focused component and it is desired to analyze the component 200 with high precision, will be now described.

When normal grid division is performed on the components 100 and 200 according to a setting that the number of grids is large in order to obtain results of analysis on the components 100 and 200 in FIG. 9 with high precision, small fundamental elements are generated almost uniformly all over the object to be numerically analyzed on the basis of the x and y axes. As shown in FIG. 10, for example, grid division is performed on the whole components 100 and 200 at 1 mm intervals, thus the number of grids is 510.

When grid division according to this embodiment is performed on the object to be numerically analyzed in FIG. 9, 1:1 is set as the allowable aspect ratio for the component 100, whereas 1:5 is set as the allowable aspect ratio for the component 200, after that, cube division is performed. On this occasion, the cube division is performed first on the component 200 that should be watched as shown in FIG. 11(A), cube division is performed secondly on the remaining component 100 as shown in FIGS. 11(B) through 11(D).

Namely, as shown in FIG. 11(A), when cube division is performed on the focused component 200 so that each cube is of the largest possible size, ten cubes each of a size of 1 mm by 1 mm are generated because the allowable aspect ratio is 1:1.

While reflecting a result of the cube division on the focused component 200, the component 100 is divided into cubes within the allowable aspect ratio 1:5 (without directivity of x and y). When the component 100 is divided into cubes in consideration of lattice points of cubes of the focused component 200, cubes at an aspect ratio of 1:10 are generated as shown in FIG. 11(B). Next, the cube division is further performed so that the aspect ratio is 1:5, as shown in FIG. 11(C). Whereby, 20 cubes each of a size of 1 mm by 5 mm within the allowable aspect ratio 1:5 are generated in an area of the component 100 contacting with the focused component 200.

Further, cube division is performed on the remaining area of the component 100 while reflecting a result of the cube division on the above area of the component 100 contacting with the focused component 200, whereby four cubes each of a size of 5 mm by 20 mm within the allowable aspect ratio 1:5 are generated, as shown in FIG. 11(D).

As above, the object to be numerically analyzed made up of two components 100 and 200 is divided into 34 cubes. In this embodiment, a result of cube division as above is used as it is as a result of the grid division. Namely, 34 grids are obtained as a result of the grid division. With respect to this result of the grid division, grids are finely generated in the focused component 200 and a portion in the vicinity of the component 200, whereas grids are coarsely generated in a portion other than the above portions, as shown in FIG. 11(D). It is thus possible to largely decrease the number of grids and largely shorten the time required for grid division or numerical analysis while securing sufficient analysis precision of the focused component 200.

When geometric data is converted into data for numerical analysis, the grid dividing apparatus 1 (the grid dividing program 20a or the data converting program 20b) according to the embodiment of this invention generates a cube division model in which each component of an object to be numerically analyzed is divided into a plurality of cubic parts within a desired allowable aspect ratio, and performs grid division (division into fundamental elements for numerical analysis at a desired aspect ratio) according to the cube division model.

Accordingly, it becomes possible to set grid division suited to the situation, decrease the number of grids, and largely shorten the time required for grid division and analysis only by changing a little existing converting software for converting geometric data into data for numerical analysis, without changing the existing grid generating software 20c or software for numerical analysis.

Particularly, when there is a component whose result of numerical analysis is to be watched, it is possible to set the aspect ratios so that fundamental elements are finely generated in the component or a portion in the vicinity of the component, whereas the fundamental elements are coarsely generated in a portion other than the above portions, as having been described with reference to FIGS. 9, 10 and 11(A) through 11(D). It is thus possible to largely shorten the time required for grid division and the numerical analysis while securing sufficient analysis precision of the focused component.

The user (operator or the like) can recognize and select, on the display unit 40, a model having the shortest possible analysis time or a model having the highest possible precision among a plurality of cube division models generated for respective aspect ratio allowable ranges while referring to information on the analysis time ratios or the precision ratios and considering the same.

In cube division, a component whose result of numerical analysis is to be watched is first divided into cubes, as described above with reference to FIGS. 11(A) through 11(D). Accordingly, it is possible to generate fine fundamental elements in the focused component, and generate coarse fundamental elements in another component. On this occasion, each component is divided into cubes of the maximum size within an allowable aspect ratio, whereby the cube division is performed without increasing the number of the fundamental elements (the number of grids).

In grid division, a result of cube division of a cube division model is used as it is as a result of grid division. It is thus possible to perform the grid division (fundamental element generation) at very high speed, using the existing grid generating software 20c as it is, without changing the grid generating software 20c.

[2] Others

Note that the present invention is not limited to the above examples, but may be modified in various ways without departing from the scope of the invention.

For example, the object to be numerically analyzed is made up of a substrate and an LSI chip in the above embodiment. However, this invention is not limited to this example. This invention can be applied to various kinds of objects to be numerically analyzed in a manner similar to that according to the above embodiment, and provide working effects similar to those provided in the above embodiment.

In the above embodiment, the aspect ratio is handled as two-dimensional data (height-to-width ratio). Practically, the aspect ratio is handled as three-dimensional data (height-to-width-to-length ratio). This invention can be basically applied to a case where the aspect ratio is a length-to-width-to-depth ratio in a manner similar to that according to the above embodiment, and provide working effects similar to those provided in the above embodiment.

### INDUSTRIAL APPLICABILITY

According to this invention, it is possible to set grid division suited to the situation, decrease the number of grids while securing sufficient analysis precision, and largely shorten the time required for grid division or analysis, only by changing a little data converting software for converting geometric shape data into data for numerical analysis, without changing existing grid generating software or software for numerical analysis.

This invention is suitable for use in a system which converts, for example, polygon data or CAD data into data for numerical analysis and performs grid division on an object to be numerically analyzed. Accordingly, this invention is considered to be very useful.

1. A grid dividing method comprising:
a setting step of, in a data converting process for converting geometric shape data of an object, which is to be analyzed numerically and is made up of a plurality of components, into data for numerical analysis, setting, for each of the components, an allowable range of aspect ratios of fundamental elements which are used for numerical analysis and are to be obtained by dividing the component into grids;
a cube dividing step of, in the data converting process, dividing each of the components into a plurality of cubes within the allowable range set at said setting step to generate a cube division model; and
a grid dividing step of dividing each of the components into grids according to the cube division model obtained at said cube dividing step to generate the fundamental elements.

2. The grid dividing method according to claim 1, wherein said setting step is executed plural times to set a plurality of the allowable ranges;
said cube dividing step is executed for each of the allowable ranges to generate a plurality of the cube division models;
said grid dividing method further comprises:
a displaying step of displaying information on the cube division models obtained at said cube dividing step on a display unit; and
a selecting step of selecting one of the cube division models according to the information displayed on the display unit at said displaying step;
at said grid dividing step, each of the components is divided into grids according to the cube division model selected at said selecting step.

3. The grid dividing method according to claim 2 further comprising:
an analysis time ratio calculating step of calculating a ratio of analysis time required for numerical analysis, which is performed by the use of each of the cube division models obtained at said cube dividing step, on the basis of the number of cubes of each of the cube division models;
the analysis time ratio calculated at said analysis time ratio calculating step being displayed as the information on the display unit at said displaying step.

4. The grid dividing method according to claim 2 further comprising:
a precision ratio calculating step of calculating a precision ratio of a result of numerical analysis, which is performed by the use of each of the cube division models obtained at said cube dividing step, on the basis of each of the cube division models;
the precision ratio calculated at said precision ratio calculating step being displayed as the information on the display unit at said displaying step.

5. The grid dividing method according to claim 1, wherein, at said cube dividing step, the component, of which a result of numerical analysis is to be watched, is divided into the cubes in first.

6. The grid dividing method according to claim 1, wherein each of the components is divided into cubes of a maximum size within the allowable range at said cube dividing step.

7. The grid dividing method according to claim 1, wherein a result of cube division of the cube division model is used as a result of grid division at said grid dividing step.

8. A grid dividing apparatus comprising:
a setting means for, in a data converting process for converting geometric shape data of an object, which is to be analyzed numerically and is made up of a plurality of components, into data for numerical analysis, setting, for each of the components, an allowable range of aspect ratios of fundamental elements which are used for numerical analysis and are to be obtained by dividing the component into grids;
a cube dividing means for, in the data converting process, dividing each of the components into a plurality of cubes within the allowable range set by said setting means to generate a cube division model; and
a grid dividing means for dividing each of the components into grids according to the cube division model obtained by said cube dividing means to generate the fundamental elements.

9. A computer readable recording medium recorded thereon a grid dividing program for making a computer execute a function of dividing an object, which is to be analyzed numerically and is made up of a plurality of components, into grids to generate fundamental elements for numerical analysis, said grid dividing program making said computer function as:
a setting means for, in a data converting process for converting geometric shape data of the object into data for numerical analysis, setting, for each of the components, an allowable range of aspect ratios of the fundamental elements;
a cube dividing means for, in the data converting process, dividing each of the components into a plurality of cubes within the allowable range set by said setting means to generate a cube division model; and
a grid dividing means for dividing each of the components into grids according to the cube division model obtained by said cube dividing means to generate the fundamental elements.

10. A computer readable recording medium recorded thereon a data converting program for making a computer execute a function of a data converting process for converting geometric shape data of an object, which is to be analyzed numerically and is made up of a plurality of components, into data for numerical analysis, said data converting program making said computer function as:
a setting means for setting, for each of the components, an allowable range of aspect ratios of fundamental elements which are used for numerical analysis and are to be obtained by dividing the component into grids; and
a cube dividing means for dividing each of the components into a plurality of cubes within the allowable range set by said setting means to generate a cube division model.
